(19) United States
(12) Patent Application Publication
(10) Pub. No.: US 2019/0234558 A1
(43) Pub. Date: Aug. 1, 2019

(54) Leak-proof lubrication system for a power device

(71) Applicants: Song Wang, Harbin (CN); Zhongyi Wang, Harbin (CN); Ting Wang, Harbin (CN); Lei Wan, Harbin (CN); Tao Sun, Harbin (CN); Yigang Luan, Harbin (CN)

(72) Inventors: Song Wang, Harbin (CN); Zhongyi Wang, Harbin (CN); Ting Wang, Harbin (CN); Lei Wan, Harbin (CN); Tao Sun, Harbin (CN); Yigang Luan, Harbin (CN)

(73) Assignee: Harbin Engineering Univeristy, Harbin (CN)

(21) Appl. No.: 16/005,407

(22) Filed: Jun. 11, 2018

(30) Foreign Application Priority Data
Jan. 29, 2018 (CN) 201810083588X

(51) Int. Cl. F16N 29/00; F16N 19/00; F16N 35/00; F16N 7/38

(52) U.S. Cl. CPC F16N 29/00; F16N 19/003; F16N 35/00; F16N 2250/04; F16N 2270/70; F16N 2210/02; F16N 7/385

(57) ABSTRACT

Provided is a leak-proof lubrication system for a power device, comprising an oil supply pump inlet pipe, an oil supply pump, an oil supply pressure gauge, an oil supply pump outlet pipe, an oil supply filter, a lubricating oil, an oil storage tank, an oil return pipe, an storage tank pressure gauge, a vacuum pump intake pipe, a vacuum pump inlet air filter, a vacuum pump and a vacuum pump exhaust pipe. The system employs a negative pressure operation method in which the pressure of the lubrication system is controlled to be lower than the outside ambient pressure, which allows a small amount of air to flow from the outside to the inside of the lubrication system along with the lubricant to return to the storage tank, preventing leakage of the lubricant from connection joints. It is suitable to be used for gas turbines or other high-speed power machines.

### CROSS-REFERENCES AND RELATED APPLICATIONS

This application claims priority of Chinese Application No. 201810083588X, entitled “Leak-proof lubrication system for a power device”, filed Jan. 29, 2018, which is herein incorporated by reference in its entirety.

### BACKGROUND OF THE INVENTION

### Field of the Invention

The invention relates to a leak-proof lubrication system of a power device, belonging to the technical field of pressure lubrication supply of machinery and power equipment.

### Description of the Related Art

In gas turbines or other power devices, the lubrication system is extremely important for lubrication and cooling of mechanical devices (such as bearings). On the one hand, lubricants are used to lubricate the rotating parts, reducing mechanical friction and reducing power consumption. On the other hand, it is necessary to take away the heat generated by the friction pair and dissipate the heat through the oil cooler to prevent the bearing from being damaged due to the high temperature caused by the friction. Therefore, lubrication and cooling are usually carried out by means of a pressure lubrication system in which a lubricating oil pump is cyclically supplied to provide a sufficient amount of oil to lubricate and cool the bearing. In the existing pressure lubrication system, the pressure lubrication mode is usually used to perform lubrication in the working process. The lubrication oil needs to reach a lubrication point by application of a large pressure and is recovered through a return oil line to an oil storage for cyclic operation. However, due to the lack of operation precision and problems in the equipment structural design, it is difficult to ensure the complete seal of the lubrication system and the main air passage during the operating process. When the oil pressure is too large, the oil will leak from the gap at the oil seal, resulting in increased oil consumption. Excessive oil consumption, on the one hand, will increase operating costs, on the other hand, will pollute the main airway or make the combustion system accumulate carbon too fast, seriously affecting the operation of the power device.

Patent No. ZL201510315504.7, entitled “a device for reducing lubricant leakage in a two-stage turbocharger”, discloses a device for reducing leakage of lubricant in a two-stage turbocharger, including a transmission section that connects the high-pressure turbocharger to the low-pressure turbocharger, which allows clean air to be transferred from the high pressure turbocharger to the low pressure turbocharger. The invention prevents the lubricating oil in the bearing housing from dispersing through the piston ring to the rear surface of the compressor wheel, thereby reducing the leakage and consumption of the lubricating oil. The invention uses a one-way valve to prevent backflow of clean air.

Patent application No. ZL201480020516.0, entitled “Method and system for preventing oil leakage in a gas turbine”, discloses a system for preventing oil leakage. When a gas turbine engine is operating, a compressed air source is used to supply enough compressed air to the oil chamber containing the turbine bearing and pressurizes the oil chamber. If the pressure supplied from the compressed air source on the engine is insufficient under certain operating conditions, an external compressed air source may be used to supply the compressed air to operate the gas turbine engine and reduce the leakage of the lubricating oil. This patent uses one-way pressurization to prevent the leakage of lubricating oil.

In Patent No. ZL 201280029574.0, entitled “Fuel System and Method of Reducing Fuel Leakage from a Fuel System”, it uses a pressurized fuel, particularly dimethyl ether (DME) or a mixture thereof, to supply a fuel system in an internal combustion engine. The system's fuel pump comprises: a pumping mechanism partially disposed in a housing containing a lubricating oil, an exhaust line connected to the housing and adapted to expel fuel vapor from the interior of the housing, a lubricating oil supply pipeline connected to the housing, a lubricating oil supply valve installed in a lubricating oil supply line, a seal installed between the pumping mechanism and the housing for preventing leakage of lubricating oil to the outside of the housing, and a drain valve installed in the waste discharge pipeline. Both the drain valve and the lubricating oil supply valve are set to close in a non-operating state of the engine to prevent leakage of fuel vapor from the housing. This invention also utilizes the switch of the valve to prevent the leakage of the fuel.

In summary, all the existing methods for preventing leakage are the containment methods. Whether it is the use of a mechanical structure seal or the use of external air pressure, the underlying mechanism is to contain oil leakage.

### DETAILED DESCRIPTION OF THE INVENTION

In order to solve the lubricant leakage problem of internal friction parts in a power device such as gas turbine, the present invention provides an oil leakage prevention system, which uses a negative pressure for lubricant return and operates the lubrication system under a negative pressure compared to outside pressure.

In one embodiment, the present invention provides a leakage-proof lubrication system for a power device such as a gas turbine comprises: an oil supply pump inlet pipe 1, an oil supply pump 2, an oil supply pressure gauge 3, an oil supply pump outlet pipe 4, an oil supply filter 5, lubricating oil 6, an oil storage tank 7, an oil return pipe 8, a storage tank pressure gauge 9, a vacuum pump intake pipe 10, a vacuum pump 12, and a vacuum pump exhaust pipe 13,

wherein the top of the oil storage tank 7 is provided with a vacuum pump intake pipe 10; the inlet end of the vacuum pump intake pipe 10 is inserted from the top of the oil storage tank 7 into the interior of the oil storage tank 7; the outlet end of the vacuum pump intake pipe 10 is connected to the inlet of the vacuum pump 12; the outlet end of the vacuum pump 12 is connected to the vacuum pump exhaust pipe 13; the top of the oil storage tank 7 is also connected with a storage tank pressure gauge 9 which detects the gas pressure in the storage tank 7,
wherein the lower portion of the oil storage tank 7 is provided with an oil supply pump inlet pipe 1 communicating with the interior of the oil storage tank 7; the oil supply pump inlet pipe 1 is connected with the oil inlet end of the oil supply pump 2; the outlet end of the oil supply pump 2 is connected to the inlet end of the oil supply pump outlet pipe 4; the pipeline of the oil supply pump outlet pipe 4 is provided with the oil supply pressure gauge 3; the outlet end of the oil supply pump outlet pipe 4 is connected to the inlet of the oil supply filter 5; the outlet of the oil supply filter 5 is connected to the inlet of the power device to be lubricated; and the oil return pipe 8 is connected with the outlet of the power device to be lubricated;
wherein the outlet end of the oil return pipe 8 is inserted into the interior of the oil storage tank 7 from the top of the oil storage tank 7 which is filled with lubricating oil 6, and wherein the liquid height of the lubricating oil 6 is higher than the height of the connection between the oil supply pipe 1 and the oil storage tank 7, and lower than the height of the outlet end of the return pipe 8 and the inlet end of the vacuum pump intake pipe 10.

In one embodiment of the invention, it further comprises a liquid level gauge 15, the two ends of which are connected with the oil storage tank 7.

In one embodiment of the invention, the lowest part of the oil storage tank 7 is provided with a waste discharge pipe connected to the inside of the oil storage tank 7; The waste discharge pipe is provided with a drain valve 16.

In one embodiment of the invention, it further comprises a control box 14 that is connected via cables with the oil supply pump 2, the oil supply pressure gauge 3, the liquid level gauge 15, the tank pressure gauge 9 and the vacuum pump 12.

In one embodiment of the invention, the internal volume of the oil storage tank 7 is 7 to 8 times of the amount of lubricating oil needed to lubricate the power device per minute.

In one embodiment of the invention, the distance between connection point of the oil supply pump inlet line 1 and the oil storage tank 7, and the lowest end of the storage tank is 100 mm.

In one embodiment of the invention, the depth of the outlet end of the oil return pipe 8 inserted into the oil storage tank 7 is 200 mm.

In one embodiment of the invention, the inlet end of the vacuum intake pump 10 is inserted into the oil storage tank 7 at a depth of 100 mm.

In one embodiment of the invention, the vacuum pump intake pipe 10 and the oil return pipe 8 are placed on different sides of the top of the oil storage tank 7.

In one embodiment of the invention, a vacuum pump inlet air filter 11 is provided on the pipeline of the vacuum pump inlet pipe 9. The gas in the oil storage tank 7 is filtered through the vacuum inlet air filter 11 before entering the vacuum pump 12 and discharged to the outside of the oil storage tank 7.

In one embodiment of the invention, one end of the vacuum pump exhaust pipe 13 is connected with the vacuum pump 12, and the other end is open to the atmosphere. Through the vacuum pump 12, the gas in the storage tank is discharged into the atmosphere outside the oil storage tank 7. The one end of the drain valve 16 is connected to the lowest level of the oil storage tank 7, and the other end leads to the outside of the oil storage tank 7.

In the present invention, the internal pressure of the power device to be lubricated, the oil supply pressure and the oil flow rate at the lubrication parts can be collected through the control box 14, which controls the oil supply pressure of the oil supply pump 2 and the internal pressure of the oil storage tank 7 (the measured value of oil tank pressure gauge 9) maintained by the work of the vacuum pump 12 and the oil level of the oil storage tank 7 (the measured value of the liquid level gauge 15).

In the present invention, a low-pressure environment is established by the vacuum pump intake pipe 10, the vacuum pump inlet air filter 11, the vacuum pump 12, and the vacuum pump exhaust pipe 13 for the lubrication system of a gas turbine or other power devices. The specific operation pressure is adjusted according to the specific need. This low-pressure lubrication system has a pressure lower than the working pressure of the device to be lubricated. The lubricating oil 6 is pressurized by the oil supply pump 2 and is supplied to the parts to be lubricated with a certain pressure. Since the pressure of the oil storage tank 7 is lower than the pressure of parts to be lubricated, the lubricating oil 6 is recovered to the oil storage tank 7 through the oil return pipe 8 under the negative pressure. Once the oil and gas mixture is drawn back to the oil storage tank 7 via the oil return pipe 8, the lubricating oil 6 falls to the bottom under the gravity, and the gas is left in the upper part of the oil storage tank 7. The gas is suctioned and filtered and discharged to the atmosphere by the vacuum pump intake pipe 10, the vacuum pump inlet air filter 11, the vacuum pump 12, and the vacuum pump exhaust pipe 13 that are connected to the upper portion of the oil storage tank 7. The control box 14 maintains the pressure in the oil storage tank 7 and lubrication parts by adjusting the oil supply pump 2 and the vacuum pump 12 to desired values, ensuring the normal operation of the lubrication system for the gas turbine or other power devices.

The lubrication system of the present invention uses the negative pressure operation mode, in which the pressure of the lubrication system is lower than the ambient pressure, to perform the lubrication. The lubricant oil pump inlet and outlet ports are under negative pressure. During the lubrication operation, the oil supply pump pressurizes the lubricating oil and sends it to the lubrication sites. By controlling the pressure of the vacuum pump and the oil supply pump, the pressure at the lubrication points is adjusted to be lower than the external pressure of the lubrication system. A small amount of air is allowed to flow from the outside to the inside of the lubrication system and flows along with lubricating oil in the direction of the return oil pipe to the oil storage tank so as to prevent the lubricating oil from leaking out of the connection joints.

The leak-proof lubrication system of the present invention is applicable to various power machinery equipment such as gas turbines.

The present invention has the following benefits:

1. The present invention provides a leak-proof lubrication system of a power device, which controls the pressure inside the lubrication system to be lower than the external pressure of the lubrication system. In this way, a small amount of air flows from the outside to the inside of the lubrication system along with the lubricating oil following the direction of the return pipe, thus preventing the leakage of the lubricating oil from the connection joints. At present, there is no reported system that uses the pressure difference between the inside and outside of the lubrication system for oil leakage prevention. There is no reported lubrication system that adopts a negative pressure operating environment. A pressure control method is employed to adjust the oil seal of the friction pair or the lubrication components in this invention. The pressure difference between the internal and external working environments are controlled to ensure that the lubricating oil is applied within the effective pressure range, which can ensure not only effective lubrication and cooling but also zero leakage. As a result, it greatly improves the operating efficiency of the lubrication system and reduces the operating cost. Since the lubrication system uses the pressure difference to control the oil leakage, it does not need to install additional one-way valves or one-way pressing devices. The present invention provides a lubrication technology simple to construct and easy to operate.

2. The present invention employs a negative pressure operation mode. The lubricating oil is sent to the lubrication parts after being pressurized by an oil supply pump. In the lubrication part, the internal pressure of the lubrication system is controlled by the vacuum pump to be slightly lower than the external air pressure, and the oil supply pump controls the oil supply pressure to achieve the desired oil flow. The system allows small amount of outside air to enter the lubrication chamber so as to prevent the leakage of oil into the mainstream air passage, and avoid contamination of the air and increased consumption of lubricating oil, and at the same time, it can satisfy the lubrication requirements of the lubrication area.

3. The whole system is centrally controlled by the control box. By collecting the internal pressure of the gas turbine or other power devices, the oil pump is controlled to generate the appropriate lubricating oil pressure. At the same time, the vacuum pump is adjusted to match the oil supply pressure and the negative system pressure to ensure proper circulation of the lubricating oil.

4. The internal volume of the oil storage tank is 7-8 times of the volume of the lubricating oil needed to lubricate the gas turbine or other power devices per minute. There is a certain space left at the upper part of the oil storage tank to ensure the separation of the oil and the air.

5. The distance between the connection point of the oil supply pump inlet pipe and the lowest end of the oil storage tank is 100 mm. The main consideration is that after a long time operation, the lubricating oil may become contaminated and impurities will accumulate at the bottom of the oil storage tank. The set height of the oil supply pipe can avoid drawing impurities from the lubricating oil.

6. The outlet end of the oil return pipe 8 is inserted into the oil storage tank 7 is at a depth of 200 mm to ensure a safe distance between the oil return pipe 8 and the oil level of the storage tank and prevent the air in the oil/air mixture sent back from the oil return pipe 8 from entering the lubricating oil level in the oil storage tank. The oil return pipe 8 is also kept away from the inlet end of the vacuum pump intake pipe 10 so that the lubricating oil droplets in the oil return pipe are prevented from being sucked away by the vacuum pump, ensuring that the oil does not leak out via the vacuum pump.

7. The inlet end of the vacuum pump intake pipe 10 is inserted into the oil storage tank 7 to a depth of 100 mm to keep a safe distance between the vacuum pump intake pipe 10 and the oil level. The insertion depth (100 mm) of the inlet end of the vacuum pump intake pipe 10 is smaller than the insertion depth (200 mm) of the outlet end of the oil return pipe 8 so as to prevent the oil droplets in the oil return pipe from being sucked away and leaking out via the vacuum pump.

8. The oil pump outlet pipe is equipped with a filter to prevent the impurities in the oil from being sent to the bearing of the power device. A filter is also placed in front of the intake pipe of the vacuum pump to prevent impurities from being sucked into the vacuum pump, and the oil in the exhaust air can also be filtered out.

9. There is a waste discharge outlet at the lowest part of the oil storage tank. After stopping for a certain period of time, some lubricating oil with impurities may be exhausted outside the oil storage tank through the waste discharge outlet. It is not necessary to replace all the lubricating oil, and partial exhaust of the lubricating oil can effectively reduce the oil consumption.

10. The vacuum pump intake pipe 10 and the oil return pipe 8 are respectively placed on both sides of the top of the oil storage tank 7 so that the two are far away from each other, preventing the oil droplets in the oil return pipe from being sucked away and leaking out via the vacuum pump.

### BRIEF DESCRIPTION OF THE DRAWINGS

FIG. 1 is a schematic view of a leakage proof lubrication system for a gas turbine or other power devices according to the present invention.

(1, oil supply pump inlet pipe; 2, oil supply pump; 3, oil supply pressure gauge; 4, oil supply pump outlet pipe; 5, oil supply filter; 6, lubricating oil; 7, oil storage tank; 8, oil return pipe; 9, storage tank pressure gauge; 10, vacuum pump inlet air pipe; 11, vacuum pump inlet air filter; 12, vacuum pump; 13, vacuum pump exhaust pipe; 14, control box; 15, liquid level gauge; 16, drain valve).

### EXAMPLES

The technical details of some embodiments of the present invention are described below with reference to the accompanying drawings in the following embodiments. The embodiments are described only for illustration purpose, not to limit the scope of the present invention which is defined by the claims hereafter.

### Embodiment 1

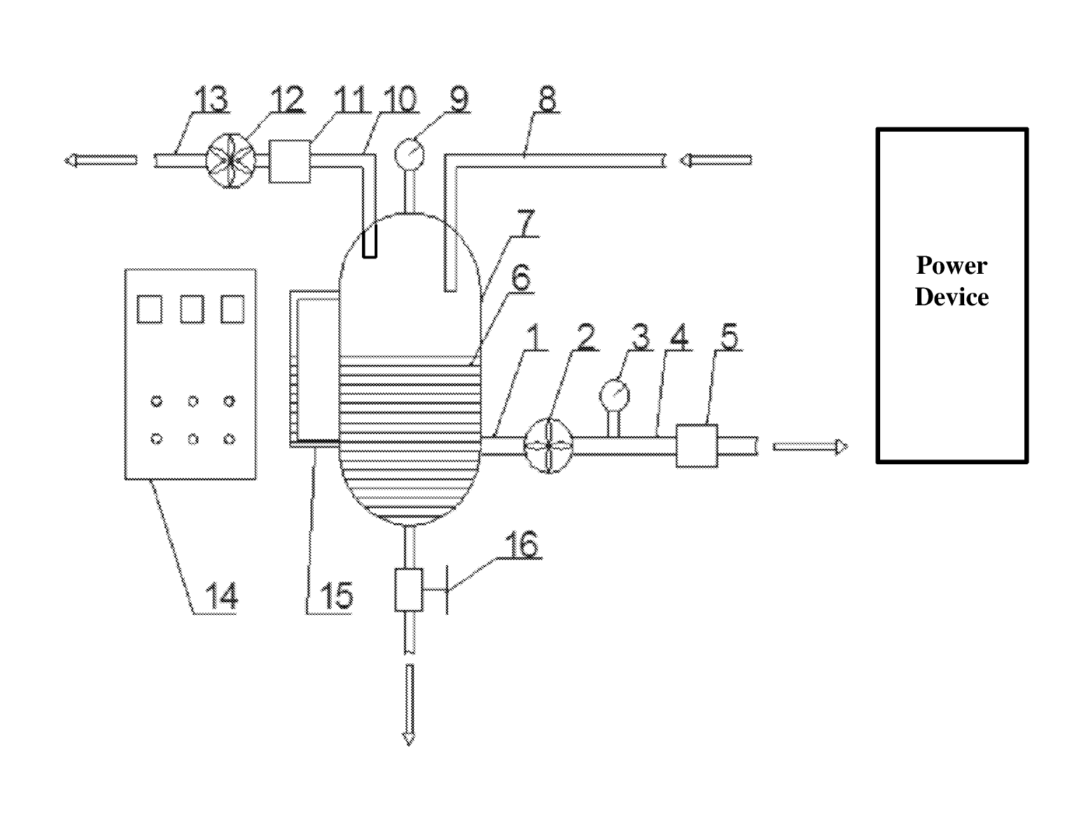

As shown in FIG. 1, the present invention provides a leakage-proof lubrication system for a power device such as a gas turbine comprises: an oil supply pump inlet pipe 1, an oil supply pump 2, an oil supply pressure gauge 3, an oil supply pump outlet pipe 4, an oil supply filter 5, lubricating oil 6, an oil storage tank 7, an oil return pipe 8, a storage tank pressure gauge 9, a vacuum pump intake pipe 10, a vacuum pump 12, and a vacuum pump exhaust pipe 13,

wherein the top of the oil storage tank 7 is provided with a vacuum pump intake pipe 10; the inlet end of the vacuum pump intake pipe 10 is inserted from the top of the oil storage tank 7 into the interior of the oil storage tank 7; the outlet end of the vacuum pump intake pipe 10 is connected to the inlet of vacuum pump 12; the outlet end of the vacuum pump 12 is connected to the vacuum pump exhaust pipe 13; the top of the oil storage tank 7 is also connected with a storage tank pressure gauge 9 which detects the gas pressure in the oil storage tank 7;
wherein the lower portion of the oil storage tank 7 is provided with an oil supply pump inlet pipe 1 communicating with the inner cavity of the oil storage tank 7; the oil supply pump inlet pipe 1 is connected with the oil inlet end of the oil supply pump 2; the outlet end of the oil supply pump 2 is connected to the inlet end of the oil supply pump outlet pipe 4; the pipeline of the oil supply pump outlet pipe 4 is provided with the oil supply pressure gauge 3; the outlet end of the oil supply pump outlet pipe 4 is connected to the inlet of the oil supply filter 5; the outlet of the oil supply filter 5 is connected to the inlet of the power device to be lubricated; and the oil return pipe 8 is connected with the outlet of the power device to be lubricated;
wherein the outlet end of the oil return pipe 8 is inserted into the interior of the oil storage tank 7 from the top of the oil storage tank 7 which is filled with lubricating oil 6; wherein the liquid height of the lubricating oil 6 in the oil storage tank 7 is higher than the height of the connection between the oil supply pipe 1 and the oil storage tank 7, and lower than the height of the outlet end of the oil return pipe 8 and the inlet end of the vacuum pump intake pipe 10.

In this embodiment of the invention, one end of the vacuum pump exhaust pipe 13 is connected with the vacuum pump 12, and the other end is connected to the atmosphere. Through the vacuum pump 12, the gas in the oil storage tank 7 is discharged into the atmosphere outside the oil storage tank 7. The internal main gas flow pressure of the power device to be lubricated, the oil supply pressure and the oil flow rate at the lubrication parts is collected through the control box 14, which controls the oil supply pressure of the oil supply pump 2 and internal pressure of the oil storage tank 7 (the measured value of the oil tank pressure gauge 9) maintained by the work of the vacuum pump 12 and the oil level of the oil storage tank 7 (the measured value of the liquid level gauge 15).

In this embodiment of the invention, a vacuum environment is established by the vacuum pump intake pipe 10, the vacuum pump inlet air filter 11, the vacuum pump 12, and the vacuum pump exhaust pipe 13 in the lubrication system of a gas turbine or other power devices. The vacuum degree is adjusted according to the specific usage. This vacuum lubrication system has a pressure lower than the working pressure of the device to be lubricated. The lubricating oil 6 is pressurized by the oil supply pump 2 and is supplied to the parts to be lubricated. Since the pressure of the oil storage tank 7 is lower than the pressure of parts to be lubricated, the lubricating oil 6 is recovered to the oil storage tank 7 through the oil return pipe 8 under negative pressure. Once the oil and gas mixture is drawn back to the oil storage tank 7 via the oil return pipe 8, the lubricating oil 6 falls under the gravity to the bottom of the oil storage tank 7, and the gas is left in the upper part of the oil storage tank 7. The gas are suctioned, filtered and discharged to the atmosphere by the vacuum pump intake pipe 10, the vacuum pump inlet air filter 11, the vacuum pump 12, and the vacuum pump exhaust pipe 13 that are connected to the upper portion of the oil storage tank 7. The control box 14 maintains the pressure in the oil storage tank 7 and the parts to be lubricated by adjusting the oil supply pump 2 and the vacuum pump 12 to desired values, ensuring the normal operation of the lubrication system.

The lubrication system of this embodiment uses the negative pressure operation mode, in which the pressure of the lubrication system is lower than the ambient pressure, to perform the lubrication. The lubricant oil pump inlet and outlet ports are under negative pressure. During the lubrication operation, the oil supply pump pressurizes the lubricating oil and sends it to the lubrication sites. By controlling the pressure of the vacuum pump and the oil supply pump, the pressure at the lubrication points is adjusted to be lower than the external pressure of the lubrication system. A small amount of air is allowed to flow from the outside to the inside of the lubrication system and flows along with lubricating oil in the direction of the return oil pipe to the oil storage tank so as to prevent the lubricating oil from leaking out of the connection joints.

This embodiment provides a leak-proof lubrication system of a power device, which controls the pressure inside the lubrication system to be lower than the external pressure of the lubrication system. In this way, a small amount of air flows from the outside to the inside of the lubrication system along with the lubricating oil following the direction of the return oil pipe, thus preventing the leakage of the lubricating oil from the connection joints. At present, there is no reported system that uses the pressure difference between the inside and outside of the oil seal for oil leakage prevention. There is no reported lubrication system that adopts a negative pressure operating environment. A pressure control method is used to adjust the oil seal of the friction pair or the lubrication components in this invention. The pressure difference between the internal and external working environments are controlled to ensure that the lubricating oil is applied under the effective pressure range, which can ensure not only effective lubrication and cooling but also zero leakage. As a result, it greatly improves the operating efficiency of the lubrication system and reduces the operating cost. Since the lubrication system uses the pressure difference to control the oil leakage, it does not need to install additional one-way valve or one-way pressing device. It provides a lubrication technology simple to construct and easy to operate.

The present embodiment employs a negative pressure operation mode. The lubricating oil is sent to the lubrication parts after being pressurized by the oil supply pump. In the lubrication parts, pressure of the lubrication system is controlled by the vacuum pump to be slightly lower than the external air pressure, and the oil supply pump controls the oil supply pressure to achieve the desired oil flow. The system allows small amount of outside air to enter the lubrication chamber so as to prevent the leakage of oil into the mainstream air passage, contamination of the air and increased consumption of lubricating oil, and at the same time, it can satisfy the lubrication requirements of the lubrication parts.

### Embodiment 2

This embodiment further comprises a liquid level gauge 15. The two ends of the liquid level gauge 15 are connected with the oil storage tank 7, and it can be used to measure the oil level in the oil storage tank 7.

### Embodiment 3

This embodiment further comprises a waste discharge pipe 16. In this embodiment, the lowest point of the oil storage tank 7 is provided with a waste discharge pipe 16 communicating with the interior of the oil storage tank 7. The waste discharge pipe has a drain valve.

In this embodiment, one end of the drain valve communicates to the lowest position of the oil storage tank 7, and the other end leads to the outside of the oil storage tank 7.

In this embodiment, a waste discharge outlet is connected to the lowest part of the oil storage tank. After stopping for a certain period of time, lubricating oil with impurities may be exhausted outside the oil storage tank through the waste discharge outlet. It is not necessary to replace all the lubricating oil, and partial exhaust of the lubricating oil can effectively reduce the oil loss.

### Embodiment 4

This embodiment further comprises a control box 14 that is connected via a cable to the oil supply pump 2, the oil supply pressure gauge 3, the liquid level gauge 15, the tank pressure gauge 9 and the vacuum pump 12.

In this embodiment, the whole lubrication system is centrally controlled by the control box 14. By collecting the main air flow pressure inside the gas turbine or other power devices, the control box controls the oil pump to generate the appropriate oil supply pressure. At the same time, the pressure of the vacuum pump is adjusted to match the oil supply pressure and the negative system pressure to ensure proper circulation of the lubricating oil.

### Embodiment 5

This embodiment further limits the internal volume of the oil storage tank 7. In this embodiment, the internal volume of the oil storage tank 7 is 7-8 times of the volume of the oil that is needed to lubricate the power device per minute, and there is a certain space left at the upper part of the oil storage tank to ensure the separation of the oil and the gas.

### Embodiment 6

This embodiment further limits the connection position of the inlet pipe of the oil supply pump 2 to the oil storage tank 7 to be 100 mm higher than the lowest point of the tank. Considering the possibility that the lubricating oil can accumulate impurities over long time of operation and the impurities likely settle to the bottom of the oil storage tank, this setting helps prevent the oil supply pump from drawing the impurities in the oil.

### Embodiment 7

This embodiment further limits the position of the oil return pipe 8. In this embodiment, the outlet end of the oil return pipe 8 is inserted into the oil storage tank 7 at a depth of 200 mm so that there is a safe distance between the oil return pipe 8 and the oil level, preventing the gas in the oil/gas mixture returned from the oil return pipe 8 from entering below the oil level in the oil storage tank.

### Embodiment 8

This embodiment further limits the position of the vacuum pump intake pipe 10. In this embodiment, the inlet end of the vacuum pump intake pipe 10 is inserted into the oil storage tank 7 at a depth of 100 mm to ensure a safe distance between the vacuum pump intake pipe 10 and the oil level, preventing the lubricating oil from being sucked into the vacuum pump intake pipe 10. Additionally, the insertion depth of vacuum pump intake pipe 10 is less than the insertion depth (200 mm) of the oil return pipe 8 so as to prevent the oil droplets in the return pipe from being sucked away and leaking out via the vacuum pump.

### Embodiment 9

This embodiment further limits the relative position of the vacuum pump intake pipe 10 and the outlet end of the oil return pipe 8. In this embodiment, the vacuum pump intake pipe 10 and the device return pipe 8 are placed far way on two different sides on the top of the oil storage tank 7. This setting helps prevent the oil droplets in the oil return pipe from being sucked away and leaking out via the vacuum pump.

### Embodiment 10

This embodiment further comprises a vacuum pump inlet air filter 11. In this embodiment, the vacuum pump air inlet pipe 9 is provided with a vacuum pump inlet air filter 11 on the pipeline. The gas in the oil tank 7 is filtered through the vacuum pump inlet air filter 11 before entering the vacuum pump 12 and being discharged to the outside of the oil storage tank 7.

In this embodiment, the oil supply pump outlet pipe is provided with a filter to prevent the impurities in the lubricant from being sent to the device bearing. A filter is placed in front of the vacuum pump intake pipe to prevent impurities from being sucked into the vacuum pump, and the lubricating oil in the exhaust air can also be filtered out.

While the present invention has been described in some detail for purposes of clarity and understanding, one skilled in the art will appreciate that various changes in form and detail can be made without departing from the true scope of the invention. All FIGURES, tables, appendices, patents, patent applications and publications, referred to above, are hereby incorporated by reference.

What is claimed is:

1. A leakage-proof lubrication system for a power device, comprising:
an oil supply pump inlet pipe 1, an oil supply pump 2, an oil supply pressure gauge 3, an oil supply pump outlet pipe 4, an oil supply filter 5, lubricating oil 6, an oil storage tank 7, an oil return pipe 8, a storage tank pressure gauge 9, a vacuum pump intake pipe 10, a vacuum pump 12, and a vacuum pump exhaust pipe 13,
wherein the top of the oil storage tank 7 is provided with a vacuum pump intake pipe 10; the inlet end of the vacuum pump intake pipe 10 is inserted from the top of the oil storage tank 7 into the interior of the oil storage tank 7; the outlet end of the vacuum pump intake pipe 10 is connected to the inlet of vacuum pump 12; the outlet end of the vacuum pump 12 is connected to the vacuum pump exhaust pipe 13; the top of the oil storage tank 7 is also connected with a storage tank pressure gauge 9 which detects the gas pressure in the storage tank 7,
wherein the lower portion of the oil storage tank 7 is provided with an oil supply pump inlet pipe 1 communicating with the inner cavity of the oil storage tank 7; the oil supply pump inlet pipe 1 is connected with the inlet end of the oil supply pump 2; the outlet end of the oil supply pump 2 is connected to the inlet end of the oil supply pump outlet pipe 4; the pipeline of the oil supply pump outlet pipe 4 is provided with the oil supply pressure gauge 3; the outlet end of the oil supply pump outlet pipe 4 is connected to the inlet of the oil supply filter 5; the outlet of the oil supply filter 5 is connected to the inlet of the power device to be lubricated; and the oil return pipe 8 is connected with the outlet of the power device to be lubricated,
wherein the outlet end of the oil return pipe 8 is inserted into the interior of the oil storage tank 7 from the top of the oil storage tank 7 which is filled with lubricating oil 6, and wherein the liquid height of the lubricating oil 6 is higher than the height of the connection point of the oil supply pipe 1 and the oil storage tank 7, and lower than the insertion height of the outlet end of the return pipe 8 and the inlet end of the vacuum pump intake pipe 10.

2. The lubrication system of claim 1, further comprises a liquid level gauge 15, wherein both ends of the liquid level gauge 15 communicates with the interior of the oil storage tank 7.

3. The lubrication system of claim 1, wherein the lowest point of the oil storage tank 7 is provided with a waste discharge pipe communicating with the interior of the oil storage tank 7, the waste discharge pipe being provided with a drain valve 16.

4. The lubrication system of claim 1, further comprises a control box 14, the control box 14 being connected via cables to the oil supply pump 2, the oil supply pressure gauge 3, the liquid level gauge 15, the storage tank pressure gauge 9 and the vacuum pump 12.

5. The lubrication system of claim 1, wherein the internal volume of the oil storage tank 7 is 7-8 times of the volume of the oil that is needed to lubricate the power device per minute.

6. The lubrication system of claim 1, wherein the oil supply pump inlet pipe 1 is connected to the oil storage tank 7 at a location 100 mm higher than the lowest end of the oil storage tank 7.

7. The lubrication system of claim 1, wherein the outlet end of the oil return pipe 8 is inserted into the oil storage tank 7 at a depth of 200 mm.

8. The lubrication system of claim 1, wherein the inlet end of the vacuum pump intake pipe 10 is inserted into the oil storage tank 7 at a depth of 100 mm.

9. The lubrication system of claim 1, wherein the vacuum pump intake pipe 10 and the oil return pipe 8 are placed on different sides of the top of the oil storage tank 7.

10. The lubrication system of claim 1, wherein a vacuum pump inlet air filter 11 is provided on the pipeline of the vacuum pump air inlet pipe 9, and gas in the storage tank 7 is filtered through the vacuum pump inlet air filter 11 before being sent to the vacuum pump 12 and discharged to the outside of the storage tank 7.
